(19) United States
(12) Patent Application Publication
(10) Pub. No.: US 2026/0368508 A1
(43) Pub. Date: Nov. 19, 2026

(54) SYSTEM AND METHOD FOR IMPROVING PREDICTIVE MODELS

(71) Applicant: Vinci4D.al, Inc., Palo Alto, CA (US)

(72) Inventors: Mustafa Hajij, Palo Alto, CA (US); Hardik Kabaria, Palo Alto, CA (US); Sarah Osentoski, Palo Alto, CA (US)

(73) Assignee: Vinci4D.al, Inc., Palo Alto, CA (US)

(21) Appl. No.: 19/677,553

(22) Filed: May 14, 2026

Related U.S. Application Data
(60) Provisional application No. 63/805,867, filed on May 14, 2025.
(60) Provisional application No. 63/823,410, filed on Jun. 13, 2025.

(51) Int. Cl. G06N 3/0495

(52) U.S. Cl. CPC G06N 3/0495

(57) ABSTRACT

The method can include receiving an input; determining a set of transformation parameters (e.g., morphism map) based on the input; and determining outputs using the transformation parameters. The machine learning model can include a set of layers wherein at least a portion of the layers are modified using the set of transformation parameters (e.g., to define effective weights). The machine learning model layers can include learned model parameters and dynamically determined input-based transformation parameters.

### CROSS-REFERENCE TO RELATED APPLICATIONS

This application claims the benefit of U.S. Provisional Application number 63/805,867 filed 14 May 2045, and U.S. Provisional application Ser. No. 63/823,410 filed 13 Jun. 2025, each of which is incorporated in its entirety by this reference.

### TECHNICAL FIELD

This invention relates generally to the machine learning field, and more specifically to a new and useful method for improving machine learning models by encoding token correlation of input data.

### BRIEF DESCRIPTION OF THE FIGURES

FIG. 1 is a schematic representation of a variant of the method.

FIG. 2 is a schematic representation of a variant of determining a morphism map.

FIG. 3 is a schematic representation of a variant of a machine learning model, modified with a set of morphism maps.

FIG. 4 is a schematic representation of a variant of training a morphism-modified machine learning model.

FIG. 5 is a schematic representation of a variant of a morphism-modified convolutional filter.

FIG. 6 is a schematic representation of a variant of determining morphisms using different transformation kernels.

FIG. 7 is a table of ten variants of copresheaf maps.

FIG. 8 is a schematic representation of a variant of defining inter-token relationships.

FIG. 9 is schematic representation of a variant of the model.

FIG. 10 is a schematic representation of a variant of the model where the input is a geometric representation.

### DETAILED DESCRIPTION OF THE INVENTION

The following description of the embodiments of the invention is not intended to limit the invention to these embodiments, but rather to enable any person skilled in the art to make and use this invention.

### 1. Overview

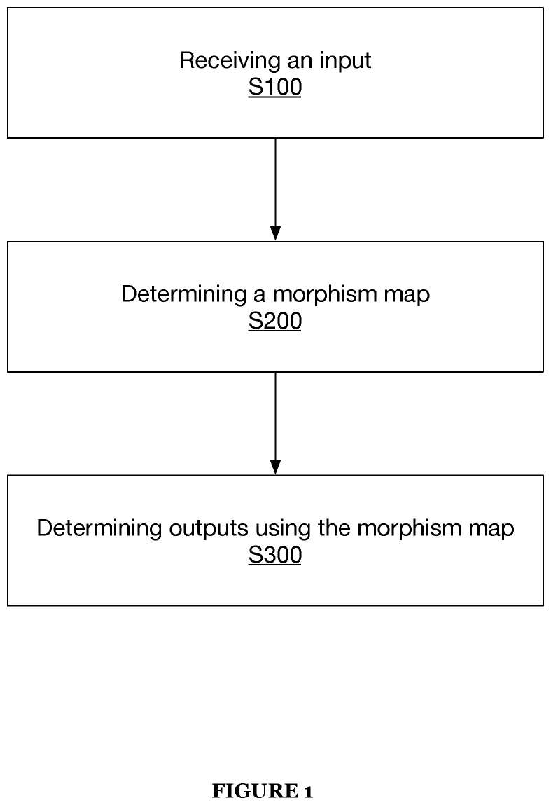

As shown in FIG. 1, variants of the method can include: receiving an input S100; determining a morphism map S200; and determining outputs using the morphism map S300. The method functions to improve the generalizability of machine learning models using localized maps (e.g., linear maps, sheaf matrices, copresheaf matrices, etc.) that capture complex, multi-dimensional relationships between input elements (e.g., tokens, feature representations, feature vectors, etc.).

In an illustrative example, the system can include a locally-aware model that includes at least one feature transformation block (e.g., transformer block, convolutional block, etc.) with a locally parametrized map (e.g., linear map, sheaf matrix, copresheaf matrix, etc.) that enables cross-token attention for Euclidean data (e.g., non-graph data). In variants, the copresheaf matrix can be locally parameterized and dynamically computed based on the feature values during the forward pass. In an illustrative example, the forward pass can include: receiving a set of input elements (e.g., generated from Euclidean data); optionally determining a set of copresheaf matrix hyperparameters (e.g., dimensions); computing a copresheaf matrix for each pair of input elements (e.g. exterior product of element, i, and element, j) using a specified kernel (e.g. dense representation, diagonal, transformation kernel, etc.); and computing an output based on the input elements and the respective copresheaf matrices. In a variant, the copresheaf matrix can be used in a transformer layer as an additional set of dynamic weights that encodes the element correlations of the input data (e.g., between pairs of input elements). During training, this enables a transformer model to learn model parameters (e.g., projection matrices, biases, etc.) that account for heterogeneity and element correlations of the input data. These model parameters can be fixed during inference, while the copresheaf matrix is dynamically computed. In another variant, the copresheaf matrices can be used in a convolutional layer as a linear map that defines the relationship between the input elements (e.g., channels of a pixel) and the output. In this variant, the copresheaf matrices can be defined to increase dimensionality, reducing the need for multiple filters typically used in traditional convolutional neural networks (CNN) and maintaining the same amount parameters used in traditional CNNs. In other variants, the copresheaf matrices can be used in multi-layer perceptron layers to define an additional weight between data-specific elements to account for local data features.

In another illustrative example, the system can include a predictive machine learning model configured to predict one or more physical fields associated with a physical system. In this example, the input can include a geometric representation of the physical system, such as a mesh and/or graph. Nodes and/or edges of the geometric representation can define input elements, wherein each input element can be associated with a feature representation including material properties, geometric information, initial conditions, boundary conditions, heat-source information, and/or any other suitable physical-system information. In variants, the system can dynamically compute copresheaf matrices between pairs of nodes based on the corresponding feature representations of the nodes during a forward pass of the machine learning model. The copresheaf matrices can encode localized anisotropic relationships, geometric connectivity relationships, multiscale thermal interactions, directional heat-transfer behavior, and/or heterogeneous material interactions between regions of the physical system. In variants, the copresheaf matrices can be integrated into one or more transformer layers of the predictive model as dynamic weight structures configured to modify self-attention operations, query-key-value computations, value-vector propagation, and/or other transformer computations. In variants, the system can predict heat-flux fields.

In another illustrative example, the method can include: receiving raw data (e.g., point cloud, molecular structure, image, graph, etc.); defining a hierarchical structure for the raw data (e.g., a combinatorial complex), wherein the hierarchical structure defines a set of cells; assigning feature values (e.g., a feature vector) extracted from raw data falling within each cell to the cell; defining a set of connections between the set of cells (e.g., using a set of selected neighborhood functions) to encode a multi-scale structure of the raw data; selecting a set of map structures (e.g., map family, such as SheafFC, outer product, SheafSPD, diagonal MLP, vision spatial, etc.) for each set of connections (e.g., each neighborhood function) to define how maps will be generated from the raw data; projecting the feature values for each cell into a set of latent space (e.g., into query, key, value spaces, into a set of attention mechanisms, into a set of embeddings, etc.); determining custom translation maps specific to directed edges connecting pairs of cells based on the features of the respective cells, using a shared learned map kernel (e.g., determined based on the selected map structure for the respective connection set); for each cell pair, converting a first cell's data into the second cell's coordinate system using a set of learned model weights (e.g., attention weights) and the respective translation map for the edge connecting the first cell to the second cell (e.g., collectively forming an effective weight); aggregating the resultant messages (e.g., translated messages) at each cell (e.g., using an aggregation function) for each connection set (e.g., each neighborhood); aggregating the messages across the connection sets (e.g., for each cell); updating the features of each cell based on the aggregated messages; and repeating feature projection, translation map determination, cell feature translation, and message aggregation for each layer of the model. The hierarchical structure and map structures are generalized (e.g., shared across different sets of raw data) and used for different runs of the model. The translation maps are custom to the raw data (e.g., determined from the feature values), specific to a directed cell pair (e.g., specific to the data for the specific cell pair; the translation maps are anisotropic), and define a localized transformation relationship between the cells' respective local representation spaces. The learned map kernels can be shared across a model layer (e.g., used to determine the messages for all or a subset of cells in the layer), and can vary between different model layers. The learned map kernels can be learned through model training (e.g., updated with the model weights during backpropagation) or learned separately and applied to the model layers. However, the system/method can be otherwise performed.

### 2. Technical Advantages

Variants of the technology can confer one or more advantages over conventional technologies.

First, variants of the technology can improve model generalizability across diverse datasets. In examples, models that incorporate morphism maps (e.g., sheaf matrices, copresheaf matrices, linear maps, etc.) can be trained to learn parameters that account for token-level heterogeneity and inter-token relationships in the input data. During training, such morphism-aware models can internalize information about structural and local variability in the data, enabling improved performance on out-of-distribution or otherwise heterogeneous data. By dynamically determining the localized relationships (e.g., morphism maps) during inference (e.g., during the forward pass, etc.), the machine learning model can generalize to multiple different types of datasets (e.g., different structures, geometries, domains, etc.). In illustrative benchmarks, these models can demonstrate an increase in generalizability (e.g., at least 5%) relative to conventional architectures. In variants where morphism maps are used in convolutional neural networks (CNNs), generalizability can be improved without increasing the total number of model parameters, as the copresheaf matrices can provide higher expressivity without relying on additional filters or layers.

Second, variants of the technology can reduce the amount of training data required to achieve target performance levels by embedding relational structure directly into the model architecture. In examples, morphism maps (e.g., copresheaf matrices computed between pairs of input tokens) can encode token-to-token correlations as part of the model's forward pass, rather than requiring the model to infer and/or learn such relationships solely through training. By explicitly incorporating these localized, data-specific interactions, the model is equipped with inductive bias tailored to each input dataset. This allows the model to learn inherent relationships of the input and output data, without the noise of dataset-specific variability and heterogeneity. As a result, the model can achieve effective performance with fewer training data sets, decreasing the burden on data collection while maintaining or improving predictive accuracy. In variants, this reduction in training data requirements can also result in faster convergence and lower computational overhead during training.

Third, variants of the technology can be integrated into multiple model architectures, including transformer layers, convolutional layers, and/or multi-layer perceptrons. In variants, the morphism maps can serve as dynamic weight sets in transformer blocks, define channel-level mappings in convolutional neural networks, or encode additional relational weights in MLPs. This flexibility allows the technology to be modularly applied across a range of machine learning workflows, enhancing both the performance and adaptability of the underlying models.

Fourth, variants of the technology can improve prediction of physical fields and physical system behavior using machine learning models configured to process geometric data, simulation data, mesh data, physical field samples, boundary conditions, material properties, and/or other physics-associated inputs. In examples, morphism maps can encode localized anisotropic relationships, heterogeneous material interactions, geometric connectivity relationships, multiscale spatial dependencies, directional propagation behavior between portions of the physical system, and/or other relationships. By embedding these localized relationships directly into model transformations, the machine learning model can more efficiently learn complex physical dynamics without requiring substantially larger model architectures, additional layers, and/or increased numbers of learned parameters. In variants, morphism-modified machine learning models can improve prediction accuracy, convergence behavior, out-of-distribution generalizability, and/or computational efficiency relative to conventional machine learning approaches that rely on globally shared latent representations or fixed learned weights alone. In variants, the technology can reduce computational cost and inference latency relative to conventional numerical simulation approaches by enabling machine learning models to approximate physical field solutions with reduced computational overhead while maintaining predictive accuracy across different geometries, mesh structures, material systems, boundary conditions, and/or operating regimes. In variants, the technology can improve prediction of stress fields, strain fields, temperature fields, pressure fields, velocity fields, multiphysics interactions, and/or other physical phenomena associated with engineering and scientific systems.

However, further advantages can be provided by the system and method disclosed herein.

### 3. Method

As shown in FIG. 1, variants of the method can include: receiving an input S100; determining a morphism map S200; and determining outputs using the morphism map S300. The method functions to improve the generalizability of machine learning models using localized maps (e.g., linear maps, sheaf matrices, copresheaf matrices, etc.) that capture complex, multi-dimensional relationships between input elements (e.g., tokens, feature vectors, feature representations, etc.).

In variants, the method can be performed using a machine learning model incorporating a set of morphism maps (e.g., copresheaf matrices), and/or using any other model. In variants, the machine learning model can handle irregular data and considers the heterogeneous relationships between datum and/or input elements (e.g., token, feature vector, feature representation, etc.) in a dataset; alternatively, the model can handle data with any other set of characteristics.

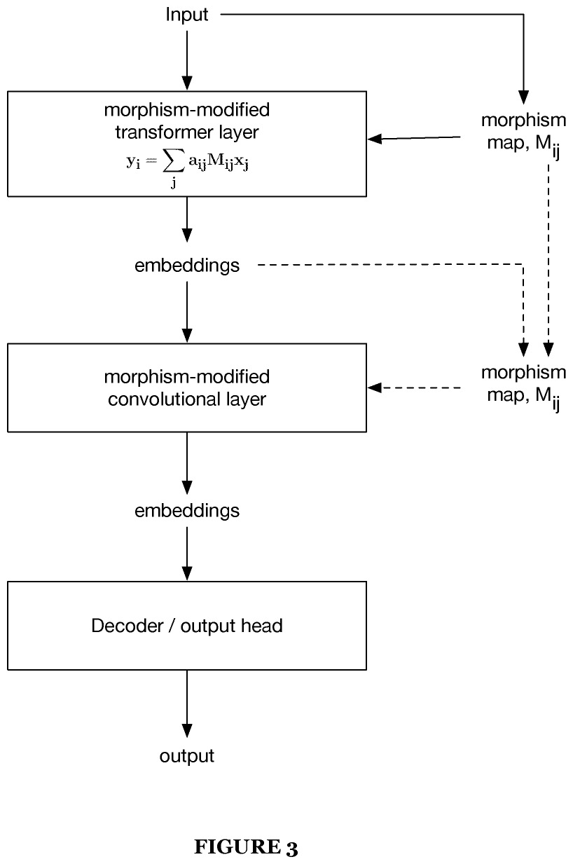

The machine learning model can be a convolutional neural network, transformer, multilayer perceptron, recurrent neural network, deep neural network, diffusion model, graph neural network, an autoencoder (e.g., encoder-decoder structure), and/or any other model architecture. The machine learning model can include convolutional layers, transformer layers, MLP layers, or any suitable machine learning model layer, that has been modified to include one or more morphism maps, as shown for example in FIG. 3. However, the machine learning model can be otherwise structured.

The morphism map can be integrated into the layers of a machine learning model, into a block of the machine learning model, into one or more nodes of the machine learning model, and/or otherwise integrated into the machine learning model; be computed separately and applied to the inputs and/or outputs of the node, layer, or block; and/or otherwise applied to the machine learning model. Morphism maps can be used in convolutional layers, transformer layers (e.g., self-attention layers, cross-attention layers, etc.), multilayer perceptron layers, recurrent layers, diffusion layers, and/or any other layers. In an example, all layers can include a morphism and/or morphism map; alternatively, only a subset of the layers include a morphism and/or morphism map. In an example, a layer can include at least one morphism map for each input element (e.g., token, feature vector, feature representation, etc.) in the input data. The morphism maps can be integrated into all layers of the machine learning model or alternatively a subset of layers of the machine learning model. However, the morphism map can be otherwise utilized.

The morphism maps are preferably dynamically computed during inference, but can alternatively be learned and fixed during inference (e.g., be part of the learned parameter set).

The model can be trained end-to-end, trained block by block (e.g., wherein different blocks are trained during independent training passes), layer by layer, node by node, and/or otherwise trained. The trained machine learning model can have a set of learned parameters (e.g., learned during training). The learned parameters can include weights (e.g., Wv, Wq, Wk, recurrent weights, input weights etc.), biases, convolutional kernels, projection matrices, scale, shift, embedding matrix, and/or other parameters. The learned parameters are preferably fixed during inference, but can alternatively be dynamically computed during inference.

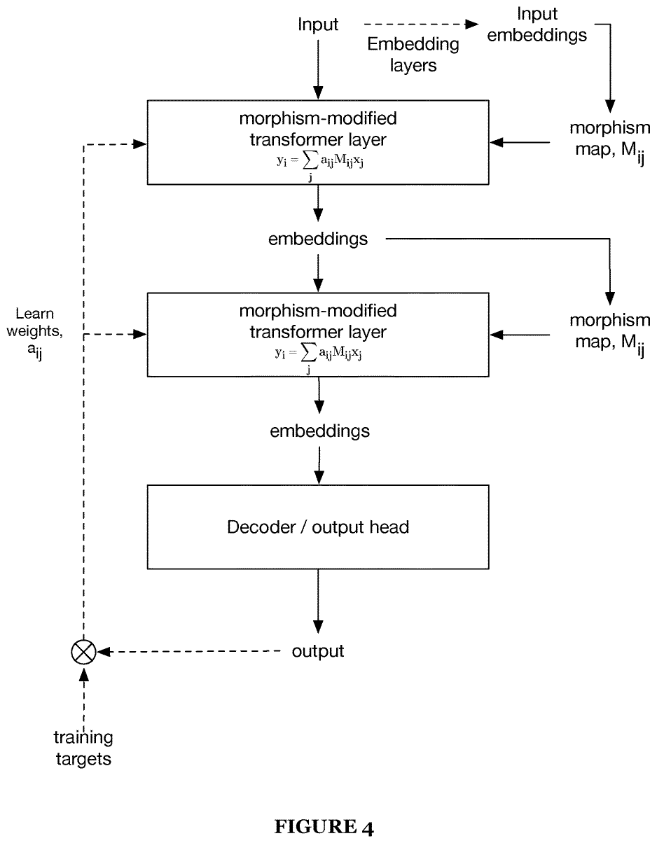

In a first variant, the remainder of the model parameters can be learned in light of dynamically-computed morphisms (e.g., wherein the model parameters are fixed, but the morphisms are dynamically computed during inference). In this variant, during training, morphisms can be computed for the training data, wherein each machine learning model can learn parameters that take into account the determined token-token relationships described by the dynamically-computed morphism map, as shown for example in FIG. 4.

In a second variant, the model parameters can be learned independently from the morphisms (e.g., during training or during a fine-tuning pass).

In a third variant, the model parameters and the morphisms can be learned during training (e.g., fixed during inference). However, the morphisms can be otherwise learned.

Morphism map-modified machine learning models can be trained to analyze: images (e.g., detect objects, extract visual features, segment images, generate images, etc.); geometries (e.g., generate geometries, encode geometries, modify geometries, etc.), physics (e.g., learn physical dynamics, predict physical fields, predict physical responses, etc.), biological data (e.g., predict molecules, predict biological responses, etc.), and/or perform other analyses on other data. In variants, models using morphism-modified layers (e.g., copresheaf-modified) layers can be at least 5% more generalizable than an analogous model without the morphism-modified layers. In variants, morphism-modified machine learning models can improve generalizability, heterogeneous-data handling, anisotropic modeling, and/or out-of-distribution performance without increasing the number of learned model parameters relative to an analogous machine learning model without morphism-modified layers.

Morphism maps or sets thereof (e.g., copresheaf maps, sheaf maps, linear maps, non-linear maps, etc.) can describe and/or quantify the connections between input elements (e.g., tokens, nodes, feature vectors, feature representations, etc.) and/or datum in a dataset, as shown for example in FIG. 8. The morphism maps can be characterized by a morphism dimension (D), data connection dimension or number of input elements (N), and/or any other hyperparameters.

The morphism dimension (D) can be a hyperparameter that describes the size of a morphism, Mᵢⱼ. where a morphism Mᵢⱼ can be a data structure (e.g. matrix, array, vector, scalar, etc.) that defines the relationship between input elements i and input elements j. A morphism with a larger morphism dimension D can encode and describe more information on element-element relationships and can encode more complicated relationships between the elements and/or datum. The map dimension can be predetermined, learned (e.g., optimized based on training data), manually specified, and/or otherwise determined.

The data connection dimension can be a parameter that describes the number of inter-datum connections. For example, in some variants, a dataset with N number of input elements can have N×N number of connections (e.g., pairwise relationships between input elements, etc.). A morphism map can describe the relationship between input elements in a data set with a matrix and/or vector (e.g., characterized by the map dimension). For example, the morphism map can be a matrix and/or vector computed using the values (e.g., feature vectors, feature representations, channels, etc.) of two input elements.

However, a morphism map can be otherwise defined.

In variants, the morphism-modified machine learning models can include predictive machine learning models configured to predict, infer, estimate, generate, classify, reconstruct, interpolate, extrapolate, and/or otherwise determine one or more outputs based on input data. In variants, the predictive machine learning models can process geometric data, simulation data, scientific data, sensor data, spatial data, temporal data, multimodal data, and/or any other suitable data. In variants, the predictive machine learning models can be configured for scientific modeling, engineering analysis, physical simulation, industrial monitoring, digital twin modeling, autonomous systems, computational imaging, biological modeling, materials modeling, and/or any other suitable predictive application.

In variants, the predictive machine learning models can be configured to predict one or more physical fields associated with a physical system, geometry, simulation domain, material system, and/or spatial region. Examples of physical fields can include stress fields, strain fields, displacement fields, deformation fields, temperature fields, heat flux fields, pressure fields, velocity fields, turbulence fields, concentration fields, diffusion fields, electric field distributions, magnetic field distributions, acoustic-pressure fields, phase-transition fields, coupled multiphysics fields, and/or any other suitable physical field. In variants, the predictive machine learning models can determine physical fields based on geometric information, mesh information, topological information, material properties, initial conditions, boundary conditions, sensor measurements, simulation states, and/or any other suitable input information.

In variants, morphism-modified machine learning models can improve prediction of physical fields and/or geometric phenomena by enabling machine learning layers to account for localized heterogeneous relationships, anisotropic interactions, multiscale structure, directional propagation behavior, irregular geometric connectivity, and/or complex spatial-temporal dependencies within the input data. In variants, dynamically determined morphism maps can improve generalizability across different geometries, mesh structures, material systems, operating conditions, boundary conditions, and/or physical domains without increasing the number of learned model parameters relative to analogous machine learning models without morphism-modified layers.

The method is preferably performed during the forward pass of a machine learning model layer, but can alternatively be otherwise performed. The method can be performed during training and/or inference. In a first variant, the method can be performed during training and inference, wherein the morphism is dynamically computed for each input element (e.g., pairs of input elements, etc.) during the forward pass. In this variant, the morphism is not learned and fixed during inference, but the dynamically computed morphism influences the model parameters (e.g., weights, biases, convolutional kernels, etc.) that are learned. In a second variant, the method can be performed during training, wherein the learned morphism is fixed and retrieved during inference. The method can be repeated one or more times for each input element, within each layer, within each block (e.g., in different layers), within each neural network (e.g., in different blocks), and/or otherwise repeated.

Receiving an input S100 functions to obtain data that can be processed and/or used as input data for making predictions using a machine learning model. The input is preferably Euclidean data, graph-based data, non-Euclidean data (e.g., text), and/or other data. The data can be: heterogeneous, have local irregularities, have directional biases, have multiscale organization, span multiple scales, span multiple domains (e.g., spanning different input modalities, different physical domains, etc.), multiple dimensions (e.g., 2D inputs, 3D inputs, spatiotemporal inputs, etc.), and/or have any other complex data attributes. In examples, the input can include text, images, numerical data sets, audio signals, geometric data (e.g., geometries, meshes, point clouds, etc.), physical fields, timeseries data, and/or any other data type. The input can be multimodal, multidimensional, contain data from multiple domains (e.g., frequency, spatial, temporal, etc.), or be otherwise heterogenous. Alternatively, the input can be homogeneous, be from a single modality, dimension, or domain, or be otherwise configured. The input is preferably not a graph or have a graph structure, but can alternatively be a graph or have a graph structure.

The input can include raw data, tokenized data, embeddings (e.g., intermediate layer outputs), and/or any other input. The tokenized data can be sampled, inferred, segmented, and/or otherwise determined from input data (e.g., raw data, etc.). Examples of tokenized data that can be used can include image tokens (e.g., patches, regions, pixels, etc.) that can be extracted using ViT, pixel identification, or other methods; geometry tokens (e.g., mesh nodes, point cloud clusters, surface patches, etc.) that can be extracted using discretization or sampling methods; physical field tokens (e.g., field samples, grid cells, etc.) that can be extracted using grid sampling or discretization methods; biological data tokens (e.g., biopolymer sequences, protein residues, molecular graphs, etc.) that can be extracted using residue identification; signal tokens (e.g., frequency bands, temporal segments, wavelet coefficients, etc.) that can be extracted using signal processing methods; and/or any other suitable tokenization method. Types of tokens that can be used can include words, pixels, voxels, points, occupancy voxel, physical field unit, embeddings thereof, and/or any other token type. The embeddings can be generated using an encoder, using prior machine learning model layers, and/or any other generation method. For example, geometries can be embedded into geometry tokens using 3Dshape2vec, a transformer, an encoder, and/or another model.

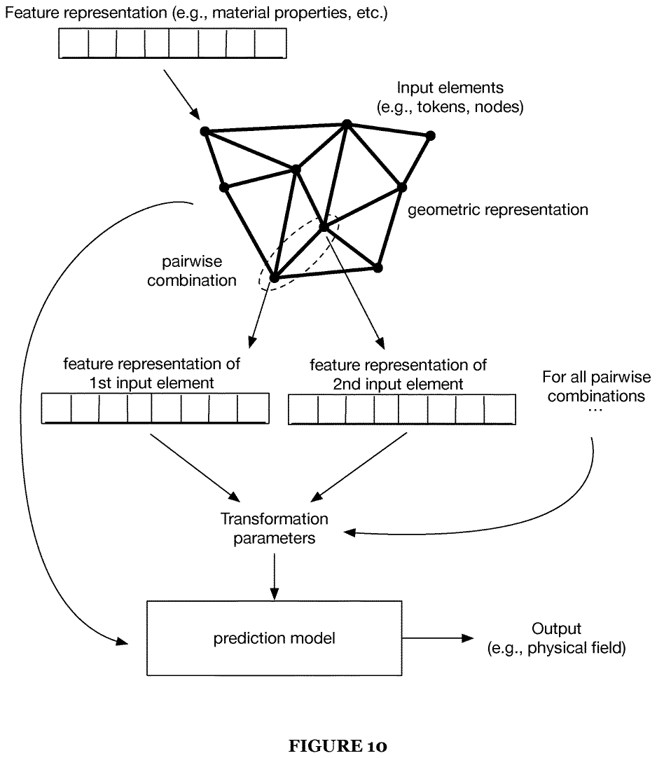

In a specific example in which the method is used to predict a physical field of a component, the input data may include a mesh, graph, and/or geometric representation associated with a physical simulation, nodes and/or edges of the mesh or graph can define tokens and/or input elements, as shown for example in FIG. 10. In this example, each node and/or edge can be associated with feature representations including material properties, boundary conditions, initial conditions, geometric properties, physical field values, simulation-state information, connectivity information, and/or any other suitable information associated with the physical system.

However, receiving an input S100 may be otherwise performed.

Determining a morphism map S200 functions to describe the relationships between different elements (e.g., tokens) of the input. S200 is preferably performed during a forward pass, but can be otherwise performed. S200 is preferably performed during training and inference, but can alternatively be performed only during training, only during inference, and/or at any other time. S200 is preferably performed using the values of the input (e.g., block input, layer input, node input, tokens, etc.), but can additionally or alternatively be performed using learned model parameters (e.g., fixed weights), and/or otherwise performed.

The morphism map can be a matrix, array, vector, functor, or have any suitable structure. The morphism map is preferably a linear map, more preferably a locally parameterized linear map, but can alternatively be a nonlinear map and/or any other suitable map. The morphism map can describe the relationships and connections between datum in the received data, or describe other connections between the data.

S200 can include determining one or more morphisms. Each input element or input element pair is preferably associated with a different morphism; alternatively, different tokens can be associated with the same morphism. Different layers can be associated with different morphisms; alternatively, different layers can be associated with the same morphism. Different layer types can be associated with the same or different morphism architecture (e.g., morphism hyperparameters). Morphisms within the same layer are preferably different in values and share the same dimensions and kernel (e.g., linear function), but can alternatively differ in dimension, kernel, and/or in any other hyperparameter. In variants, the morphisms can define localized relationships between representation spaces associated with different input elements and/or portions of the input data. For example, a morphism can parameterize propagation, transformation, weighting, conditioning, and/or interactions between feature representations associated with different input elements, neighborhoods, modalities, spatial regions, temporal regions, and/or other portions of the input data.

In a first variant, determining a morphism map S200 can include dynamically computing the morphism map, which functions to compute a locally parametrized morphism that accounts for local connections within the input data.

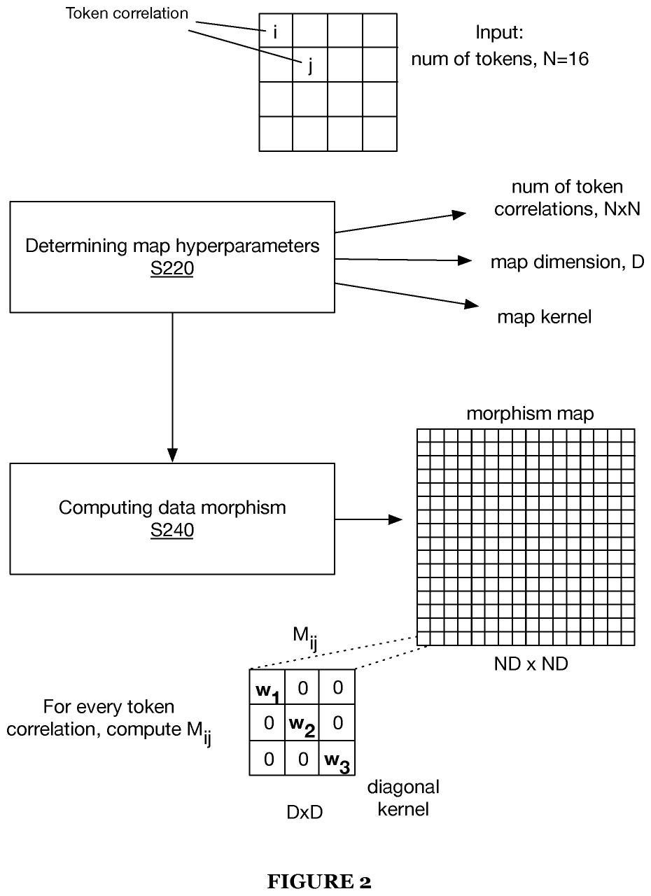

In variants, dynamically computing the morphism map can include: optionally determining map hyperparameters of the morphism map S220; and computing data morphisms S240, as shown for example in FIG. 2. However, the morphism map can be otherwise computed.

Determining map hyperparameters of the morphism map S220 can function to determine the structure of the morphism map. Map hyperparameters can include or define the morphism map's structure, dimensions, shape, and/or other parameters of the morphism map. The map structure is preferably the shape of the morphism map (e.g., dimensions of the morphism map), but can additionally or alternatively be the sparsity or otherwise defined. The map structure for S220 can be predetermined, specified by a user, retrieved, computed, selected (e.g., based on the input data values, etc.), and/or otherwise determined.

The morphism and/or morphism map can be defined by an association dimension and/or morphism dimension; the dimensions of the input data and/or the number of input element (e.g., token) associations; and/or other parameters. The association and/or morphism dimension (D) can be set as a hyperparameter, manually selected, learned, dynamically computed or selected (e.g., based on the input values, etc.), randomly selected, determined using heuristics, iteratively tuned, or otherwise determined. For example, a user can tune a dimension, D, that specifies the size of a matrix that encodes the association between two input elements (e.g., tokens).

The dimensions of the input data and/or the number of element associations are preferably determined based on the overall number of input elements (e.g., token) in the input, but can alternatively be manually set or otherwise determined. For example, data with N number of input elements can have N×N number of associations. In variants where a morphism map is used with or in lieu of a convolutional layer, the number of associations can be the number of associations within a convolution filter. That is, a convolution filter with dimensions 3×3 may have nine input element associations.

In variants, the morphism map of S220 can include a set of morphisms, wherein each morphism describes the association between a set of input elements (e.g., token). In a first variant, the morphism map can have the dimensions ND×ND. N is preferably the same as the input dimensionality (e.g., number of tokens in the input), but can alternatively be larger (e.g., to increase the output dimensionality) or smaller (e.g., to decrease the output dimensionality) than the input dimensionality. For example, a morphism can be determined for every input element association, wherein each morphism can be configured as a D×D matrix, where collectively, the morphism map for N input elements can be ND×ND. In a second example, a morphism can be determined for a subset of the input element associations (e.g., morphisms can be determined for specific tokens, determined using a sliding window approach, etc.). In a third example, a user can change the dimensionality of the input by changing the dimensions of the morphism map. In an illustrative example, a morphism map can be configured as a linear map for multiple channels by having an additional dimension (e.g. a 3D matrix, 4D matrix, 4D+ matrix, etc.).

In some variants, S200 can include processing the input and/or feature representations associated with the input to determine one or more intermediate representations for morphism determination. In these variants, the hyperparameters of the of the morphism map can be dependent on the processed input data. In variants, processing the input can include determining embeddings, latent representations, projected representations, encoded representations, higher-dimensional representations, and/or any other suitable representations associated with tokens and/or input elements. In variants, processing the input can include increasing the dimensionality of feature representations prior to morphism determination, which can increase representational capacity, relational expressivity, information density, and/or the ability of the morphism map to encode complex, multiscale, anisotropic, heterogeneous, and/or nonlinear relationships between portions of the input data. Processing the input can be performed using one or more machine learning models including multilayer perceptrons, encoder models, transformer blocks, convolutional layers, graph neural network layers, embedding models, projection layers, recurrent layers, autoencoders, diffusion models, and/or any other suitable machine learning model or computational component. In variants, one or more models and/or modules used to determine the embeddings can be trained as part of end-to-end training of the prediction model, trained separately from other components of the prediction model, pretrained and subsequently fine-tuned, fixed during training of other model components, and/or otherwise trained or configured.

However, S220 can be otherwise performed.

Computing data morphisms S240 functions to determine values that describe the relationship between input elements of the input data. The data morphisms are preferably dynamically recomputed during each model execution run (e.g., during each instance of the forward pass), such that S240 is performed during both inference and training; alternatively S240 can be performed during training, performed during inference, and/or performed at any other time.

Computing a data morphism (Mᵢⱼ) can include: determining data associated with two or more input elements; quantifying a relationship between the two or more input elements (e.g., computing a morphism from the input element data and/or features); and/or otherwise computing the data morphism. In examples, determining data associated with tokens can include defining a neighborhood of data around each token.

The data morphism (Mᵢⱼ) can include linear maps, non-linear maps, matrices, vectors, functions, and/or any other mathematical structures that describe the relations between input elements. The data morphism is preferably a copresheaf matrix (e.g., sheaf matrix, cellular sheaf matrix, etc.), but can additionally or alternatively be any other morphism. In variants, the copresheaf matrix can represent, define, and/or parameterize a sheaf, a sheaf neural network, a neural sheaf diffusion, a sheaf attention network, a connection Laplacian SNN, a heterogeneous sheaf neural network, an adaptive sheaf diffusion, a cellular sheaf, and/or other structures. The data morphism is preferably specific to a input element pair (e.g., token i, token j pair), but can alternatively be specific to a single input element, to a set of input elements (e.g., tuple), and/or otherwise related to individual input elements.

In examples, quantifying a relationship between input elements to determine a data morphism can include computing a quantity and/or quantities that utilizes the two or more input elements (e.g., the quantity can be a weight, a product, a cross-product, a dot product, an exterior product, an average, a normalization, etc.).

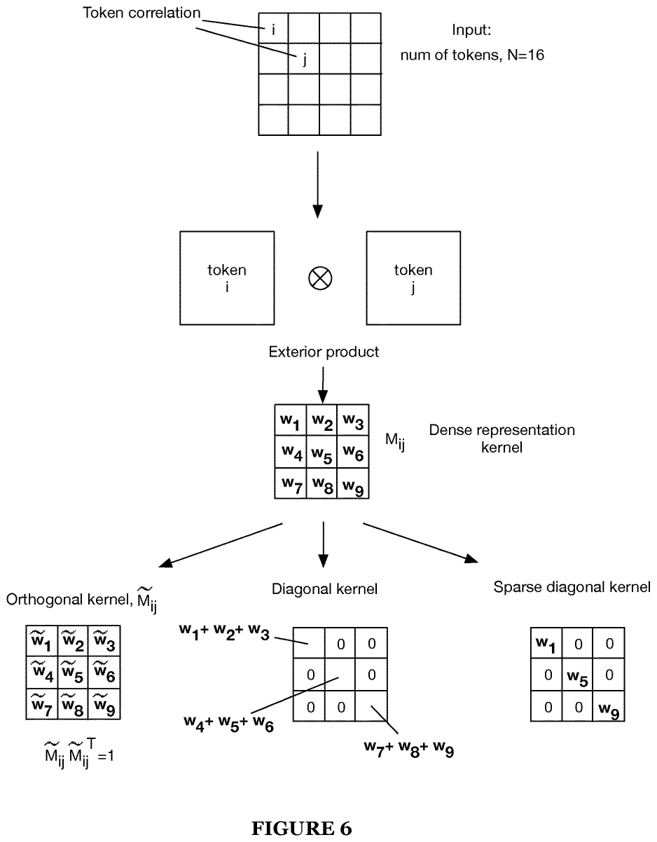

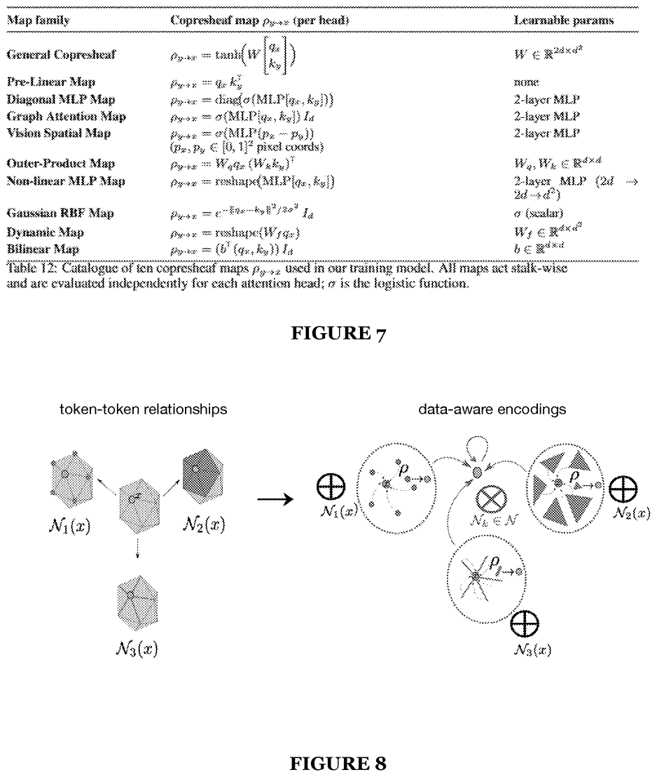

The data morphism (Mᵢⱼ) can be defined by a kernel (e.g., transformation kernel). The kernel (e.g., transformation kernel) can be predetermined, dynamically selected (e.g., during each execution instance), selected randomly, selected for model performance optimization, or otherwise chosen. The same or different kernel can be used for different input element sets in the same layer, different layers in the same block, different blocks in the same neural network, and/or otherwise used. Examples of kernels (e.g., transformation kernels, etc.) that can be used include a dense representation, a diagonal copresheaf, a sparse diagonal copresheaf, an orthogonal copresheaf, and/or any other kernel. The dense representation morphism can be computed by taking the exterior product of the two input elements, as shown for example in FIG. 6. The diagonal copresheaf morphism can be computed by taking the exterior product of two input elements, calculating the sum of each row and/or column, and creating a diagonal matrix with the sums. The sparse diagonal copresheaf morphism can be computed by taking the exterior product of two input elements and setting every non-diagonal quantity of the matrix to zero. The orthogonal copresheaf morphism can be computed by taking the exterior product of two input elements, then performing singular value decomposition to determine a nearest orthogonal matrix. FIG. 7 presents ten variants for computing copresheaf maps. However, the data morphism can be otherwise computed.

In some variants, computing the data morphism S240 can include processing token data, embeddings, feature representations, and/or other intermediate representations using one or more machine learning models and/or computational layers configured to determine morphisms. The machine learning models can include multilayer perceptrons, transformer layers, encoder models, graph neural network layers, convolutional layers, projection layers, recurrent layers, diffusion layers, and/or any other suitable computational component. In variants, the machine learning models used to compute the morphisms can be trained as part of end-to-end training of the machine learning model, trained independently from other portions of the machine learning model, pretrained and subsequently fine-tuned, fixed during training of other model components, and/or otherwise trained or configured.

In variants, a morphism map in S240 can change the dimensionality between the input and output of a layer. This can be used to output a target layer size (e.g., increasing the number of channels in a convolution), and/or otherwise used. A morphism map can be a linear map defining how an input element or set of input elements relates to an output element with increased dimensionality, or be otherwise configured. For example, the morphism map can include a set of weights describing the contribution of each input element (e.g., token) for each channel of an output element (e.g., output token). In variants, increasing the morphism dimension can increase the representational capacity of the morphism map by enabling the morphism map to encode more complex, abstract, multiscale, anisotropic, and/or heterogeneous relationships between tokens.

In variants, determining a morphism map S200 can include retrieving a predetermined morphism, wherein morphisms can be learned for each input element index or input element index pair during training and retrieved during inference (e.g., based on a token index, token value, etc.). For example, morphisms can be learned for the data structure and/or data type of the input. In variants, determining the morphism map can include aggregating, arranging, indexing, concatenating, stacking, grouping, ordering, mapping, combining, and/or otherwise structuring a set of morphisms associated with the input data. In variants, the morphisms can be organized according to pairwise combinations of input elements, neighborhoods of input elements, layer associations, spatial relationships, temporal relationships, graph connectivity relationships, and/or any other suitable organizational structure. In variants, determining the morphism map can include populating entries of a matrix, tensor, array, lookup structure, graph structure, sparse structure, dense structure, and/or any other suitable data structure using the determined morphisms.

However, determining a morphism map S200 may be otherwise performed.

Determining outputs using the morphism map S300 functions to determine an output based on the input data with a machine learning model that incorporates the morphism map. The outputs can be embeddings, intermediate predictions (e.g., numerical values, classifications, segmentations, predictions, physical fields, physical responses, geometries, etc.). The output is preferably determined by using the morphism map as a transformation (e.g., weight matrix) on the data, but can be otherwise determined. In an example, the product, dot-product, outer product, and/or other transformation between the morphism map and the input data can be computed to determine the output.

In variants, determining outputs using the morphism map S300 can include determining effective model weights based on the morphism map and a set of learned model parameters. For example, the effective model weights can be determined using products, weighted combinations, additive combinations, gating operations, masking operations, concatenation operations, attention-weighted combinations, dynamically parameterized kernels, and/or any other suitable combination of the morphism map and the learned model parameters.

The morphism map can be applied: before the forward pass (e.g., applied to the inputs, applied before forward pass execution by the model block layers; early “fusion”, etc.), applied during the forward pass (e.g., applied while computing the output, applied to intermediate outputs, applied by the model block layers; middle “fusion”, etc.), applied after the forward pass (e.g., applied to the output of the model block; late “fusion”, etc.), and/or performed at any other point in the forward pass.

In a first variant, determining outputs S300 can include computing an output using a morphism-modified transformer block. The morphism map can be integrated in a transformer layer as an additional “weight” in the attention mechanism. For example, an output can be computed using:

yᵢ=ΣⱼαᵢⱼMᵢⱼxⱼ Equation 1

where yᵢ is the output, Mᵢⱼ is the morphism map, xᵢ is an input token, and αᵢⱼ are weights and/or attention coefficients learned during training. In this variant, αᵢⱼ Mᵢⱼ can be defined as an effective weight. The weights and/or attention coefficients αᵢⱼ can be dynamically computed as a function of Q, K, and V, where Q is a query matrix computed from a learned query weight matrix and an input token embedding matrix; K is a key matrix computed from a learned key weight matrix and the input token embedding matrix; and V is a value matrix computed from a learned value weight matrix and the input token embedding matrix. The inputs to the morphism-modified transformer block can be raw data values, encodings, and/or other values. The morphism can be otherwise incorporated into the transformer layer.

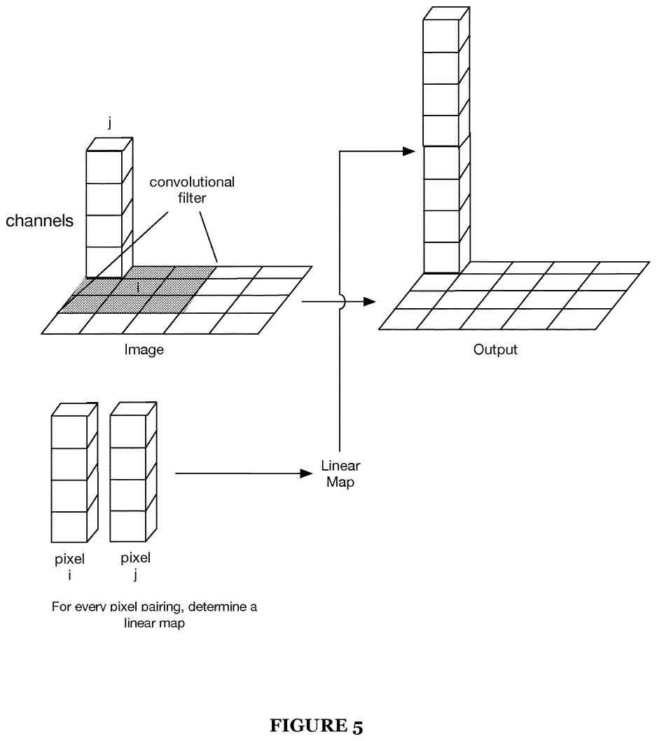

In a second variant, determining outputs S300 can include computing an output using a morphism-modified convolutional block, as shown for example in FIG. 5. The morphism map is preferably used in addition to the convolutional kernel, but can alternatively be used in lieu of the convolutional kernel. In variants where the morphism map is used for convolutions, the morphism map can include spatial weights that define token correlations which can be separate from a learned convolution weight, integrated with the learned convolution weight, or the same as the convolution weight. In a first embodiment, the convolutional filter includes or is generated from a morphism map (e.g., a subset of the convolutional filter weights can be learned, and a subset of the convolutional filter weights can be dynamically computed based on input token values). In a first example, the convolutional filter (e.g., acting as a morphism map) defines each output channel as a linear map of two input tokens, i and j. In a second example, the convolutional filter (e.g., acting as a morphism map) can describe how to compute output token, j, as a function of input token, i, such that sliding the convolutional layer allows output token, j, to be uniquely dependent on the surrounding data. In a second embodiment, the learned convolutional weights can be additionally weighted with the morphism map (e.g., with coefficients and/or parameters that describe token correlations). For example, a section of a morphism map (e.g., a single morphism of the morphism map, etc.) corresponding to a position and/or spatial location of a convolutional filter (e.g., a center of the convolutional filter, center of an input matrix, etc.) can be applied to the convolutional filter (e.g. as a product, dot product, exterior product, weight, normalization factor, etc.) Morphisms can be otherwise incorporated into a convolutional layer.

In a third variant, determining outputs S300 can include determining data embeddings using a morphism-modified encoder. For example, determining data embeddings using a morphism-modified encoder can include computing a valued morphism map from raw data inputs (e.g., S200), and computing data embeddings using the valued morphism map and the raw data inputs. However, the embeddings can be otherwise determined. The embeddings can be used as an input for a morphism-modified downstream block, for a downstream block without a morphism modification (e.g., without a copresheaf matrix), and/or for any other neural network block.

In variants, determining outputs using the morphism map S300 optionally includes decoding encoded data to determine a model prediction S340, which functions to determine a model prediction based on the encoded data. S340 can be performed after a machine learning model layer, after input data has passed multiple encoding layers, or as a last step of a machine learning model (e.g., MLP, transformer, CNN, etc.). The model prediction can include: predicted values, classifications, and/or any output type. For example, in variants where the model is a multilayer perceptron model, S340 can include an output layer learning weights used to compute a final output from the encoded data, where the final output may contain useful, interpretable data (e.g., predicted physical measurements, analytical solutions, etc.). In variants where the model is a CNN, S340 can include using an output head to determine classifications for the input data (e.g., for object detection, segmentation, etc.). In variants where the model is a transformer, S340 can include using a decoder head to predict a final sequence (e.g., for natural language processing, for sequential data, etc.).

However, decoding encoded data to determine a model prediction S340 may be otherwise performed.

Determining outputs using the morphism map S300 may be otherwise performed.

### 4. System

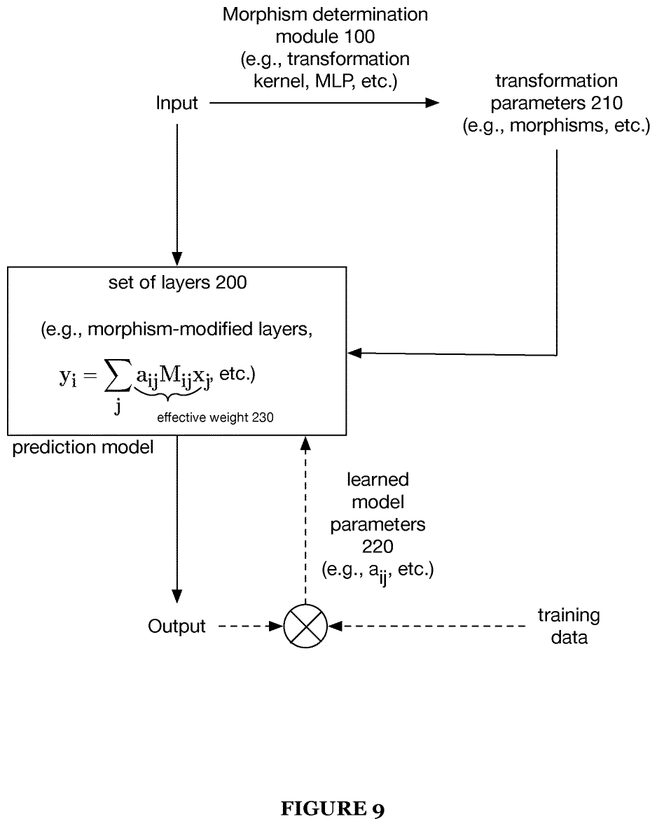

As shown in FIG. 9, in variants, the system and/or prediction model can include a module for determining a set of morphisms (e.g. morphism-determination module 100); and a set of layers 200. The set of layers can include transformation parameters 210 (e.g., morphisms), learned model parameters 220, and optionally effective weights 230. The system and/or model functions to improve predictive machine learning models using dynamically determined localized transformation operators that encode relationships between portions of input data and modify model computations based on the encoded relationships. In variants, the system can improve generalizability without increasing the number of learned model parameters. In variants, the system can reduce the amount of training data required to achieve a target predictive accuracy.

In variants, the prediction model can include transformers, convolutional neural networks, graph neural networks, multilayer perceptrons, diffusion models, recurrent neural networks, autoencoders, physics-informed neural networks, multimodal neural networks, topological neural networks, and/or any other type of prediction model.

In variants, the system and/or prediction model can determine (e.g., predict, infer, output, compute, etc.) physical field predictions. Examples of physical fields can include mechanical fields (e.g., stress fields, strain fields, displacement fields, deformation fields, stiffness distributions, damage fields, fatigue fields, crack-propagation fields, etc.), thermal fields (e.g., temperature fields, heat flux fields, radiation fields, phase-transition fields, etc.), chemical fields (e.g., concentration fields, diffusion fields, reaction-rate fields, probability-density fields, etc.), electrical fields (e.g., electric potential fields, electric field distributions, current-density fields, charge-density fields, etc.), electromagnetic fields (e.g., magnetic field distributions, wave-propagation fields, etc.), fluid fields (e.g., velocity fields, pressure fields, turbulence fields, vorticity fields, density fields, porosity fields, permeability fields, etc.), acoustic fields (e.g., acoustic-pressure fields, etc.), optical fields (e.g., optical-intensity fields, etc.), diffusion fields (e.g., diffusion distributions, transport fields, etc.), quantum fields (e.g., quantum probability fields, wavefunction distributions, etc.), biological fields (e.g., biological concentration fields, protein-expression fields, cell-density fields, etc.), phase fields (e.g., phase-transition fields, phase-boundary distributions, etc.), multiphysics fields (e.g., coupled thermo-mechanical fields, electrochemical fields, fluid-structure interaction fields, etc.), and/or any other physical fields. The prediction can be based on input data that include geometric information and/or representation, material property information, boundary condition, topological information, initial conditions, loading conditions, and/or any other suitable data. However, the system and/or prediction model can determine any other suitable values based on any suitable information. For example, the system and/or prediction model can be used for analyzing and/or processing images, sensor data, time-series data, and/or any other data.

In variants, the system can include one or more models configured to process structured data, unstructured data, Euclidean data, non-Euclidean data, graph data, geometric data, physical simulation data, multimodal data, and/or any other data. The model(s) can receive, as input, numerical data, images, text, audio, video, geometric data (e.g., meshes, point clouds, voxels, etc.), physical field data, simulation data, time-series data, multimodal data, and/or any other suitable input.

In variants, the input data can include input elements. Examples of input elements can include tokens, nodes, mesh elements, voxels, patches, feature vectors, field samples, graph nodes, combinatorial complex cells, and/or any other suitable input elements. In variants, each input element can be associated with a feature representation, an embedding, a local coordinate system, a local feature space, a local representation space, and/or any other suitable information.

In a specific variant, the input data can be structured as a graph, and can include nodes and edges describing connectivity. In this variant, a node and/or edge can be input elements. For example, in variants, a geometric mesh, grid, and/or other geometric representation can be passed as input. In this example, nodes of the geometric representation can be associated with other input modalities (e.g., as feature vectors, etc.) such as material properties, local geometric information, and/or any other information.

In variants, the system and/or prediction model can include one or more layers modified using dynamically determined transformation parameters 210 (e.g., morphisms, transport operators, local transformation operators, sheaf maps, copresheaf maps, matrix-valued operators, etc.). In variants, the prediction model can utilize localized transformation parameters and/or morphisms to encode relationships and/or interactions within the input data. Examples of relationships can include token relationships, node relationships, local geometric relationships, directional couplings, anisotropic relationships, heterogeneous latent-space relationships, cross-domain interactions, multiscale relationships, and/or any other relationships.

In variants, the transformation parameters 210 (e.g., morphisms) can define mappings, transformations, correlations, and/or relationships between local representation spaces associated with different portions of the input data. In variants, the morphisms 210 can be dynamically determined during inference based on the input data. In some variants, the morphisms can additionally and/or alternatively be determined during training and fixed during inference. However, the transformation parameters 210 can be determined at any suitable time.

In variants, the system and/or prediction model can determine effective model weights based on the morphism. For example, effective model weights can be based on a set of learned model parameters and a set of dynamically determined localized transformation parameters. In variants, the system and/or prediction model can utilize the morphisms to modify one or more attention operations, message-passing operations, convolution operations, feature propagation operations, latent-space transformations, value-vector transformations, query-key-value computations, and/or any other suitable aspects. The latent embeddings (e.g., QKV, messages, input data, features, feature representations, etc.) generated by one or more layers of the model are preferably in a non-human-readable latent space (e.g., learned through model training), but can alternatively be in a human-readable space (e.g., human-readable features, human-designed features), or be otherwise constructed. The use of morphisms can improve model generalizability, heterogeneous-data handling, anisotropic modeling, long-range dependency modeling, multiscale representation learning, out-of-distribution performance, relational reasoning, data efficiency, and/or any other suitable performance characteristic.

In variants, training all or portions of the system and/or prediction model can include jointly training the learned model parameters and morphisms, training the learned model parameters while dynamically recomputing the morphisms, fixing the morphism while training model parameters, and/or any other training procedure. In variants, training all or portions of the system and/or prediction model can be performed using supervised learning, self-supervised learning, contrastive learning, reinforcement learning, physics-informed learning, diffusion training, and/or any other suitable approach.

The morphism-determination module 100 functions to determine one or more localized transformation operators (e.g., morphisms, morphism maps) and/or transformation parameters 210 describing relationships between portions of the input data. In variants, the morphism-determination module 100 can determine morphisms and/or morphism maps, sheaf maps, copresheaf maps, transport operators, matrix-valued operators, linear maps, anisotropic maps, directional transformation operators, and/or any other such determinations. In variants, the morphism-determination module can include a set of machine learning layers, computation, transformations, functions, models, and/or any other suitable components. The morphism-determination module is preferably a component, a layer, a set of layers, and/or any set of components integrated within the predictive model. In other variants, the morphism-determination module can be separate from the predictive model.

In variants, the morphism-determination module 100 can determine morphisms for combinations of input elements, neighborhood of input elements, each layer of a model, each attention head of the model, each convolution region of the model, and/or any other suitable targets.

In variants, a morphism can include a localized transformation operator associated with one or more input elements that encodes relationships, interactions, correlations, directional associations, and/or propagation behavior between corresponding feature representations. In variants, a morphism can include a matrix, a vector, a tensor, a linear map, a nonlinear map, a transport operator, a sheaf map, a copresheaf map, and/or any other morphism. For example, a morphism can encode the relationship between any two input elements of the input data (e.g., pairwise combination of elements, etc.). In this example, each pairwise combination of input elements can be associated with a different morphism. However, in other examples, the morphisms can be the same across the input elements.

In variants, a morphism map can include a structured collection of morphisms associated with an input that can organize relationships between multiple input elements and is configured to modify computations performed by a machine learning model. Morphisms can be aggregated to define a morphism map associated with the input data. In variants, aggregation can include arranging, indexing, concatenating, stacking, grouping, ordering, mapping, combining, and/or otherwise structuring the morphisms. In variants, the morphism map can comprise a matrix, a tensor, an array, a lookup structure, a graph structure, a sparse structure, a dense structure, and/or any other structure.

In variants, aggregation can include populating entries of the morphism map using morphisms associated with corresponding pairwise combinations of input elements. In variants, aggregation can include defining an ordered set of morphisms corresponding to pairwise combinations of input elements. In variants, aggregation can include generating a data structure configured for retrieval of morphisms during model computation. For example, the morphism map can define a tensor, matrix, indexed data structure, and/or any other organization of morphisms. In a first specific example, the morphism map can include a morphism for every pairwise combination of input elements in the input data. In a second specific example, the morphism map can include morphism(s) for each layer of the model. In a third example, the morphism map can include morphisms for a subset of combinations of input element.

In variants, the morphism-determination module 100 can determine the morphisms (e.g., transformation operator, transformation parameters, etc.) and/or morphism maps based on input values, feature representations, embeddings, geometric relationships, spatial relationships, semantic relationships, distance relationships, topological relationships, and/or any other relationships or inputs.

In a first variant, the morphisms can be determined based on the input data. In a second variant, the morphisms can be determined based on embeddings of the input data. In this variant, input data can be passed through a machine learning model (e.g., MLP, encoder, etc.) to determine a set of embeddings, and the morphism maps can be determined based on the embeddings. By determining the morphisms based on embeddings, the system can generate higher-dimensional relational representations than may be directly available from the raw input data, enabling the morphisms to encode more complex, abstract, multiscale, anisotropic, and/or heterogeneous relationships between input elements. In variants, the embeddings can increase the dimensionality of the feature representations prior to morphism determination, thereby increasing the representational capacity, expressivity, and/or information density of the resulting morphism maps.

In variants, the morphism-determination module 100 can determine morphisms using outer products, cross products, cross-correlations, similarity metrics, mapping operations, transformation operations, translation operations, kernel operations (e.g., transformation kernels, etc.), learned projection functions, neural networks, multilayer perceptrons, transformer blocks, convolutional operations, and/or any other suitable approach

In variants, the morphism-determination module 100 can determine one or more morphisms having dense matrix structures, sparse matrix structures, diagonal matrix structures, orthogonal matrix structures, low-rank matrix structures, block matrix structures, and/or any other matrix structures.

In variants in which the morphism-determination module includes machine learning models (e.g., for determining input embeddings, for determining the morphisms, etc.), the machine learning models can be trained as part of the end-to-end training of the prediction model, separately from other components of the prediction model, and/or in any other suitable manner. In variants, the morphisms can be dynamically computed during training, inference, each forward pass, each layer execution, and/or any other time. In variants, the morphism-determination module can determine different morphisms for different layers, model blocks, attention heads, input modalities, and/or any other components.

Morphisms and/or transformation parameters 210 can be determined based on a set of hyperparameters. Examples of hyperparameters can include morphism dimensions, operator dimensions, number of pairwise relationships, number of neighborhoods, kernel types, operator sparsity, operator rank, and/or any other hyperparameters. In variants, the morphism dimension can define the dimensionality of a morphism associated with a pairwise relationship between input elements. In variants, the morphism hyperparameters can be predetermined, user-specified, learned, dynamically selected, optimized during training, randomly initialized, and/or otherwise configured. In a variant, the morphism dimension can be based on the dimensions of the input data and/or input elements associated with the morphism. For example, the morphism dimension can be the same as or less than a dimension of the feature representation of an input element. Alternatively, the morphism dimension can be larger than the feature representation (e.g., by increasing dimensionality, etc.).

However, the morphism-determination module may be otherwise configured.

The set of layers 200 functions to perform machine learning computations using the input data and the morphisms (e.g., to predict a physical field). The set of layers can include transformer layers, self-attention layers, cross-attention layers, convolutional layers, graph message-passing layers, diffusion layers, MLP layers, recurrent layers, and/or any other layers. In variants, each layer can include morphisms 210, learned model parameters 220, and/or optionally effective weights 230.

In variants, each layer of the set of layers can include learned model parameters, weights, coefficients, and/or other parameters that are learned, optimized, predefined, and/or otherwise determined. Learned model parameters 220 can function to define and/or parametrize model computations. In variants, the learned model parameters can include projection matrices, attention weights, convolution kernels, biases, embedding matrices, recurrent weights, scale parameters, shift parameters, and/or any other learned model parameters. In variants, the learned model parameters can be trained in the presence of dynamically determined morphisms. In variants, the learned model parameters 220 can learn representations that account for local heterogeneity, token correlations, directional relationships, anisotropic propagation, multiscale interactions, and/or any other suitable relational structure.

In variants, at least one layer of the set of layers can include a set of learned model weights and/or learned model parameters 220 and a set of dynamically determined transformation parameters 210 (e.g., morphisms, morphism map). In variants the transformation parameters can be determined by the morphism-determination module 100 or using any suitable method. In variants, the morphism map can modify feature propagation, message aggregation, value-vector transport, query-key-value computations, attention weights, convolution kernels, layer outputs, and/or any other aspect thereof.

In variants, the set of layers can optionally define effective weights 230 based on the learned model parameters 220 and the transformation parameters 210 and/or morphisms. The effective weights can function as a joint representation of the learned model parameters and transformation parameters. For example, the effective weights 230 can be the product of the morphisms and the learned model parameters, a weighted combination of the morphisms and the learned model parameters, an additive combination of the morphisms and the learned model parameters, a concatenation-based transformation of the morphisms and the learned model parameters, an attention-weighted combination of the morphisms and the learned model parameters, a gating operation based on the morphisms and the learned model parameters, a projection of the learned model parameters into a morphism-conditioned representation space, a masking operation based on the morphisms, a dynamically parameterized kernel determined based on the morphisms and the learned model parameters, and/or any other suitable combination, transformation, conditioning, modulation, or parameterization operation.

In variants, the effective weights 230 can be dynamically determined during inference. However, the effective weights can be determined at any suitable time.

In variants, different layers of the set of layers can utilize different configurations, different localized morphisms, different operator dimensions, different transport mechanisms, different local representation spaces, and/or any other varying components. In some variants, the learned model parameter and localized morphisms and/or transformation parameters can be consistent throughout layers. However, the different layers can be otherwise configured.

In variants, the learned model parameters can remain fixed during inference while the localized morphisms are dynamically computed based on the input. For example, across inference runs, the learned model parameters can be constant, while the localized morphisms and/or transformation parameters are changed, modified, and/or re-computed. In this variant, the effective weights can be changed, modified, and/or recomputed based on the transformation parameters. However, in other variants, the learned model parameters, transformation parameters, and/or effective weights can otherwise vary, change, and/or remain constant across multiple inference runs.

However, the transformation parameters 210, learned model parameters 220, and effective weights 230, can be otherwise configured.

However, the set of layers may be otherwise configured.

The following examples illustrate representative use cases of the method and are provided for illustrative purposes. These examples are not intended to be exhaustive and should not be construed as limiting the scope of the invention. In a first specific example, the prediction model can include a model configured to process both geometric data and material property data associated with a physical system. In this example, a geometric mesh can define a set of nodes (e.g., input elements), while material property information can define feature vectors associated with each node. A morphism-determination module can determine morphisms between the different node feature vectors using learned embedding models and multilayer perceptrons configured to project the data into higher-dimensional embedding spaces. In variants, the morphisms can define matrix-valued relationships between local geometric regions. The morphisms can modify latent-space transformations and/or attention operations of a transformer model to improve coupling between geometric structure and physical behavior. In variants, the system can predict heat fields.

In a second specific example, the prediction model can include a convolutional neural network configured to process spatial regions of an input image. In this example, pixels can define input elements while channels can define feature vectors for each pixel. A morphism-determination module can determine morphisms associated with neighboring convolution regions based on local feature embeddings generated by one or more encoder layers. For example, the morphisms can be determined using convolutional operations, similarity metrics, cross-correlations, kernel operations, and/or any other suitable computation. In variants, the morphisms can comprise dense matrices and/or low-rank matrices configured to modify convolution kernels and/or feature propagation operations of one or more convolutional layers.

In a third specific example, the prediction model can include a transformer model configured to process sequential simulation states associated with a time-dependent physical process. In this example, temporal states can define input elements. A morphism-determination module can dynamically determine morphisms during each forward pass based on temporal embeddings and spatial embeddings associated with the input elements. For example, the morphisms can be determined using learned projection layers. The morphisms can modify self-attention operations to encode directional temporal propagation behavior, spatial-temporal coupling, multiscale interactions, and/or anisotropic evolution of the physical system over time.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken lines in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising, at a model:
receiving an input comprising a set of input elements, wherein each input element comprises a feature representation;
at a layer within the model, for each pairwise combination of input elements in the set of input elements:
determining a set of transformation parameters based on the feature representations of the first input element and the feature representations of the second input element, wherein each set of transformation parameters transforms the feature representation of the first input element into a local representation space of the second input element;
determining a set of effective weights of the model based on the sets of transformation parameters for the pairwise combinations and a plurality of learned model weights; and
determining an output based on the set of effective weights and the plurality of feature representations.

2. The method of claim 1, wherein the model comprises a neural network comprising a plurality of layers, wherein different sets of transformation parameters are determined at each layer.

3. The method of claim 1, wherein each of the set of transformation parameters is determined using a shared transformation kernel and the respective feature representations of the first input element and the second input element.

4. The method of claim 3, wherein the transformation kernel is different across different layers of the model.

5. The method of claim 3, wherein the transformation kernel comprises a set of transformation weights that are learned alongside the learned model weights during model training.

6. The method of claim 1, wherein the input comprises a geometric representation comprising a set of nodes associated with material property information, wherein the output comprises a physical field.

7. The method of claim 1, wherein the set of transformation parameters are predicted using a machine learning model based on the feature representations of the first input element and the feature representations of the second input element.

8. The method of claim 1, wherein each pairwise combination of input elements is associated with a different set of transformation parameters.

9. The method of claim 1, wherein each set of transformation parameters is dynamically determined during inference based on the input.

10. The method of claim 1, wherein the model comprises a transformer.

11. The method of claim 1, wherein determining the output comprises utilizing the sets of transformation parameters as cross-attention weights.

12. The method of claim 1, wherein each set of transformation parameters is anisotropic.

13. The method of claim 1, wherein the feature representation of each input element comprises embeddings of a set of raw data associated with each input element, wherein the method further comprises determining the embeddings using a set of learned embedding weights and the set of raw data.

14. A predictive model comprising:
an input head configured to receive an input comprising a plurality of input elements;
a set of layers, each comprising:
a set of input-dependent transformation parameters determined based on feature representations of the input elements within pairwise combinations of the plurality of input elements, wherein the set of input-dependent transformation parameters transforms information associated with a first input element into a local representation space associated with a second input element;
a plurality of learned weights;
wherein at least one layer of the set of layers is configured to process the feature representations of the input elements based on both the plurality of learned weights and the set of input-dependent transformation parameters;
wherein the predictive model is configured to determine a physical field based on the input.

15. The predictive model of claim 14, wherein the plurality of input elements comprises nodes of a mesh, wherein the physical field comprises a heat field, wherein feature representations comprise a set of material property information.

16. The predictive model of claim 14, wherein different input elements are associated with different local representation spaces, wherein the set of input-dependent transformation parameters convert a first local representation space of a first input element to a second local representation space of a second input element.

17. The predictive model of claim 14, wherein the set of input-dependent transformation parameters is dynamically determined during inference based on the input.

18. The predictive model of claim 14, wherein different layers of the plurality of layers comprise different sets of input-dependent transformation parameters.

19. The predictive model of claim 14, wherein the sets of input-dependent transformation parameters are determined by a multilayer perceptron (MLP) model.

20. The predictive model of claim 19, wherein the MLP model is trained alongside the predictive model.
